(19) United States
(12) Patent Application Publication
(10) Pub. No.: US 2007/0056303 A1
(43) Pub. Date: Mar. 15, 2007

(54) Refrigerator

(75) Inventors: Sang-geun Choi, Gwangju-city (KR); Tae-ho Joo, Gwangju-city (KR); Jong-hoon Oh, Gwangju-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/519,945

(22) Filed: Sep. 13, 2006

(30) Foreign Application Priority Data
Sep. 13, 2005 (KR) 2005-85230
Nov. 4, 2005 (KR) 2005-105439

(51) Int. Cl. F25D 23/12; G01K 13/00; F25D 11/02

(52) U.S. Cl. 62/259.2; 62/441; 62/129

(57) ABSTRACT

A refrigerator including a main body forming a storage compartment to have an opening part in a front side thereof, and a door opening/closing the opening part and including an outer door plate and an inner door plate distanced each other to form a foaming space therebetween, includes a display unit displaying an image, a display accommodating part formed in the door to accommodate the display unit, and a radiating part interposed between the display unit and the outer door plate to contact therewith respectively, and transferring heat generated from the display unit to the outer door plate. Thus, the refrigerator efficiently radiates heat of a display unit.

### CROSS-REFERENCE TO RELATED APPLICATIONS

This application claims priority from Korean Patent Application Nos. 2005-0105439, filed on Nov. 4, 2005 and 2005-0085230 filed on Sep. 13, 2005, in the Korean Intellectual Property Office, the disclosure of which is incorporated herein by reference.

### BACKGROUND OF THE INVENTION

1. Field of the Invention

The present invention relates to a refrigerator, and more particularly, to a refrigerator efficiently radiating heat of a display unit.

2. Description of the Related Art

Generally, a refrigerator stores and preserves food and has various additional functions. Recently, a refrigerator of a side-by-side type has a display unit provided in a door thereof and performing additional functions such as an internet function, a television function, etc. Heat is generated from the display unit when it is driven. A conventional refrigerator radiating the heat generated from the display unit by using a fan is disclosed in Korean Patent Application No. 2003-94937.

However, in the conventional refrigerator, the configuration thereof is complicated and noises may occur because of the fan.

### SUMMARY OF THE INVENTION

Accordingly, it is an aspect of the present invention to provide a refrigerator that efficiently radiates heat of a display unit.

The foregoing and/or other aspects of the present invention can be achieved by providing a refrigerator including a main body forming a storage compartment to have an opening part in a front side thereof, and a door opening/closing the opening part and including an outer door plate and an inner door plate distanced from each other to form a foaming space therebetween, including a display unit displaying an image, a display accommodating part formed in the door to accommodate the display unit, and a radiating part interposed between the display unit and the outer door plate to contact therewith respectively, and transferring heat generated from the display unit to the outer door plate.

According to the embodiment of the present invention, the display accommodating part is formed to be concave in the door, and the radiating part includes a radiating main body forming a predetermined space with respect to the concave portion of the display accommodating part, and a door contacting part contacting with the outer door plate.

According to the embodiment of the present invention, the radiating part further includes a horizontal bent part bent from an upper portion of the radiating main body, a vertical bent part bent from the horizontal bent part, and an inclining part inclined from the vertical bent part.

According to the embodiment of the present invention, the concave portion of the display accommodating part is formed by cutting off the outer door plate, and the refrigerator further includes a sealing member preventing a foaming material from leaking out of the cutting portion.

According to the embodiment of the present invention, the radiating part includes at least one of aluminum and copper.

According to the embodiment of the present invention, the refrigerator further includes an outer cover provided in front of the radiating part to cover the door contacting part and allowing the heat transferred to the radiating part to transfer to the outer door plate through the door contacting part.

According to the embodiment of the present invention, the display unit includes a display panel forming an image, a front cover supporting a front side of the display panel, and a rear cover covering a rear side of the display panel and contacting with the radiating part coupled with the front cover to transfer heat, and the rear cover is provided with a plurality of through holes.

The foregoing and/or other aspects of the present invention are also achieved by providing a refrigerator including a main body forming a storage compartment to have an opening part in a front side thereof, and a door opening/closing the opening part and including an outer door plate and an inner door plate distanced from each other to form a foaming space therebetween, including a display unit displaying an image, a display accommodating part formed in the door to accommodate the display unit, and a radiating part including a radiating main body forming a predetermined space with respect to the display accommodating part, a door contacting part bent from an upper portion of the radiating main body to contact with the outer door plate, and a ventilating part interposed between the radiating main body and the door contacting part.

According to the embodiment of the present invention, the refrigerator further includes an outer cover disposed around a circumference of the display accommodating part to cover the door contacting part and to form a predetermined space with respect to the outer door plate, and

a door ventilating part provided in an upper portion of the outer door plate to discharge air passed through the ventilating part to the outside.

According to the embodiment of the present invention, the radiating part further includes a horizontal bent part bent from an upper portion of the radiating main body, a vertical bent part bent from the horizontal bent part, and an inclining part inclined between the vertical bent part and the door contacting part, and the ventilating part is formed in the inclining part.

According to the embodiment of the present invention, the door ventilating part is distanced at a predetermined height from an upper end portion of the foaming space.

According to the embodiment of the present invention, the refrigerator further includes a protruding part protruding toward the inner door plate from the door ventilating part.

According to the embodiment of the present invention, the display accommodating part is formed by cutting off the outer door plate, and the refrigerator further includes a sealing member preventing a foaming material from leaking out of the cutting portion.

According to the embodiment of the present invention, the display unit includes a display panel forming an image, a front cover supporting a front side of the display panel, and a rear cover covering a rear side of the display panel to be coupled with the front cover and contacting with the radiating part to transfer heat, and the rear cover is provided with a plurality of through holes.

According to the embodiment of the present invention, the radiating part includes at least one of aluminum and copper.

Additional aspects and/or advantages of the invention will be set forth in part in the description which follows and, in part, will be apparent from the description, or may be learned by practice of the invention.

### BRIEF DESCRIPTION OF THE DRAWINGS

The above and/or other aspects and advantages of the prevent invention will become apparent and more readily appreciated from the following description of the exemplary embodiments, taken in conjunction with the accompany drawings, in which:

FIG. 1 is a front view illustrating a refrigerator according to a first embodiment of the present invention;

FIG. 2 is an exploded perspective view illustrating a main portion of the refrigerator in FIG. 1;

FIG. 3 is a sectional view illustrating the main portion of the refrigerator in FIG. 1;

FIG. 4 is an exploded perspective view illustrating a main portion of a refrigerator according to a second embodiment of the present invention; and

FIG. 5 is a sectional view illustrating the main portion of the refrigerator in FIG. 4.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below so as to explain the present invention by referring to the figures.

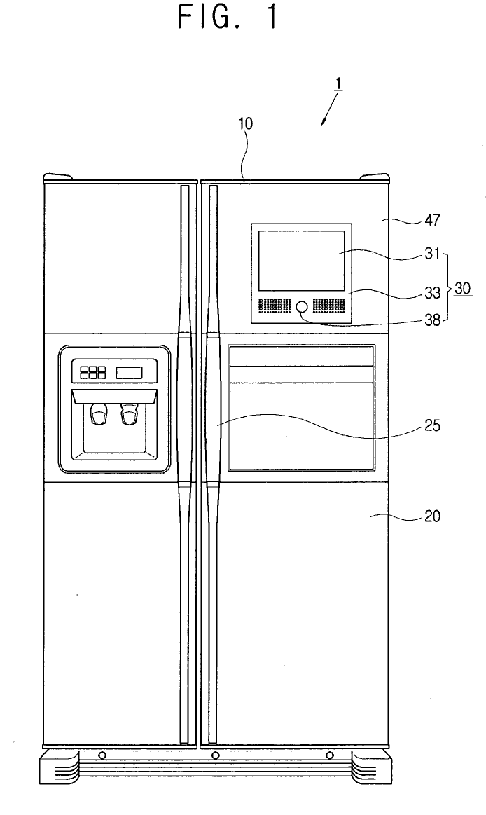

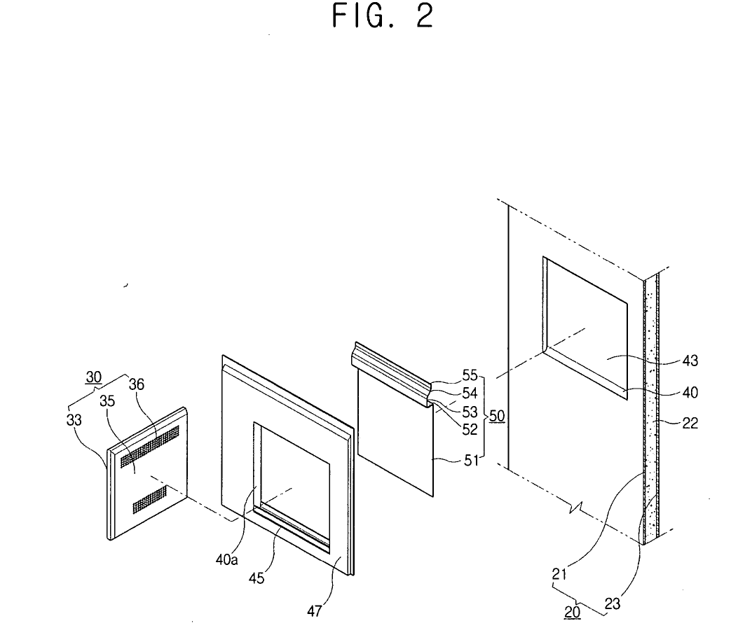

As shown in FIGS. 1 to 3, a refrigerator 1 according to a first embodiment of the present invention includes a main body 10 forming a storage compartment (not shown) having an opening part in a front side of the storage compartment, a door 20 opening/closing the opening part, a display unit 30 displaying an image, a display accommodating part 40 formed in the door 20 to accommodate the display unit 30, a radiating part 50 provided to the display accommodating part 40 and contacting with the display unit 30 to transfer heat, and an outer cover 47 provided in front of the radiating part 50.

The main body 10 is provided with the storage compartment storing food or the like, such as a freezing compartment and a refrigerating compartment, and a cooling unit (not shown) supplying cool air to the storage compartment. The main body 10 is provided as a side-by-side type, which has the storage compartments disposed side by side.

The door 20 is provided with an outer door plate 21 forming the appearance, and an inner door plate 23 spaced from the outer door plate 21 to form a foaming space 22 for a heat insulator therebetween. The outer door plate 21 is provided with a door handle 25 for grasping the door 20 in opening/closing the door 20, and the display accommodating part 40 accommodating the display unit 30. The inner door plate 23 is provided with a plurality of guards (not shown) for storing therein articles such as bottles, etc.

The display unit 30 includes a flat display panel 31 forming an image such as an LCD panel or the like, a driving circuit (not shown) driving the flat display panel 31, a front cover 33 supporting a front side of the flat display panel 31, and a rear cover 35 covering a rear side of the flat display panel 31 and contacting with the radiating part 50 to transfer heat. The display unit 30 is provided with an operating button 38 for inputting or selecting information, and a connection port (not shown) connected with a connector (not shown) to receive power. The display unit 30 may be provided with a battery (not shown) storing the power received through the connection port. The flat display panel 31 is preferably provided as a touch screen type for inputting or selecting the information without difficulty. The display unit 30 may be provided with a wireless communicating part (not shown) communicating data wirelessly with an external electronic device. Accordingly, the display unit 30 can perform an Internet function, even if the display unit 30 is detached from the door 20. The display unit 30 may be mounted in any portion of the door 20. For example, the display unit 30 is mounted in a middle portion of the door 20 in the illustrated embodiment, but alternatively, the display unit 30 may be mounted in an upper portion or other portions thereof.

The rear cover 35 covers the rear side of the flat display panel 31 and contacts with the radiating part 50 directly to transfer to the radiating part 50 the heat which is generated from the display unit 30 when the display unit 30 operates. The rear cover 35 is formed with a plurality of through holes 36. In the state that the display unit 30 is used with being detached from the door 20, the through holes 36 radiate the heat from the display unit 30 by means of air flow. It is preferable for the rear cover 35 to be formed of a plastic material, but alternatively, the rear cover 35 may be formed of metal with good thermal conductivity such as aluminum and copper.

The display accommodating part 40 is formed to be concave in the door 20 to have an opening in a front side thereof and to accommodate the display unit 30. The display accommodating part 40 has a size and a shape to correspond to the display unit 30. The display accommodating part 40 is preferably provided by cutting off a portion of the door 20, but alternatively, the display accommodating part 40 may be provided by recessing a portion of the door 20. In the case that the display accommodating part 40 is provided by cutting off a portion of the door 20, a sealing member 43 may be attached to prevent the heat insulator from leaking. The sealing member 43 is preferably formed of a plastic material, but alternatively, the sealing member 43 may be formed of metal with good thermal conductivity such as aluminum, copper, iron or the like. In a lower portion of the display accommodating part 40, a display supporting part 45 is provided to support the display unit 30.

The display supporting part 45 supports a lower portion of the display unit 30 to prevent the display unit 30 from detaching from the display accommodating part 40. The display supporting part 45 may be provided in a U shape to accommodate the lower portion of the display unit 30. However, the display supporting part 45 may be provided in other various configurations. Also, the display supporting part 45 may allow the display unit 30 to be detachably mounted to the display accommodating part 40.

The radiating part 50 includes a radiating main body 51 contacting with the display unit 30, and a door contacting part 55 provided in an upper portion of the radiating main body 51 to contact with the outer door plate 21. The radiating part 50 further includes a horizontal bent part 52 bent from the upper portion of the radiating main body 51, a vertical bent part 53 bent from the horizontal bent part 52, an inclining part 54 inclined from the vertical bent part 53. The radiating part 50 contacts with the rear cover 35 of the display unit 30 and transfers the heat generated from the display unit 30 to the outer door plate 21, and thereby radiating the heat efficiently. The radiating part 50 is preferably formed of metal with good thermal conductivity such as copper, aluminum or the like. The radiating part 50 is preferably formed in a plate shape.

A predetermined space 59 is formed between the radiating main body 51 and the display accommodating part 40. The radiating main body 51 contacts with the rear cover 35 of the display unit 30, and the door contacting part 55 contacts with the outer door plate 21, for heat exchanges. The radiating main body 51 is preferably formed in a plate shape. The space 59 between the display accommodating part 40 and the radiating main body 51 prevents the heat of the radiating part 50 transferred from the display unit 30 from transferring to the storage compartment.

The horizontal bent part 52 is bent toward the opening of the door 20 from the upper portion of the radiating main body 51. The horizontal bent part 52 is spaced at a predetermined distance from an end portion of the outer door plate 21 and extends the space 59 up to an upper portion of the radiating part 50.

The vertical bent part 53 is bent in the vertical direction from the horizontal bent part 52. The vertical bent part 53 is preferably spaced from the outer door plate 21 to form the space 59.

The inclining part 54 is formed to be inclined at a predetermined angle from the vertical bent part 53. The inclining part 54 supplies an elastic force to allow the door contacting part 55 to be supported to the outer door plate 21. Accordingly, the door contacting part 55 may surface-contact with the outer door plate 21 without contact inferiority.

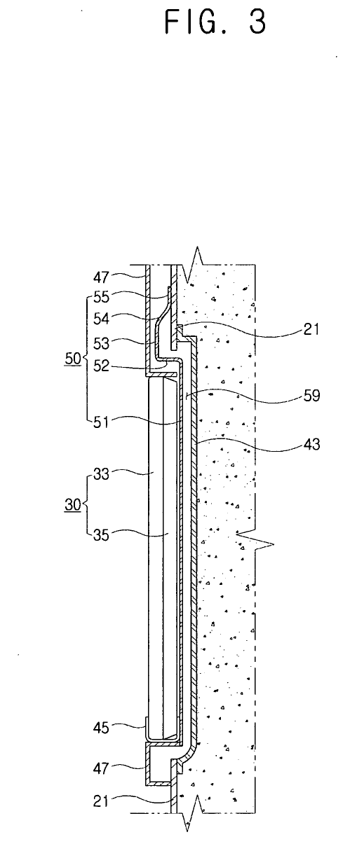

The door contacting part 55 extends from the inclining part 54 to contact with the outer door plate 21 and to support the outer door plate 21 so that the radiating part 50 may transfer the heat to the outer door plate 21 in the upper portion of the radiating part 50. The door contacting part 55 preferably surface-contacts with the outer door plate 21 to transfer the heat of the radiating part 50 to the outer door plate 21. Accordingly, the door contacting part 55 may transfer the heat transferred from the display unit 30 to the outer door plate 21, and thereby radiating the heat. The door contacting part 55 preferably has such a length as to efficiently radiate the heat. The radiating part 50 is preferably formed in a rectangular plate shape as illustrated in FIG. 3, but alternatively, the radiating part 50 may be formed in other various shapes as long as the radiating part 50 may contact with the rear cover 35 of the display unit 30 to transfer the heat to the outer door plate 21. The door contacting part 55 is provided in the upper portion of the radiating part 50 to surface-contact with the outer door plate 21, but alternatively, the door contacting part 55 may be provided in both upper and lower portions of the radiating part 50 to expand contact areas with respect to the outer door plate 21, or the door contacting part 55 may be provided around a circumference of the radiating part 50.

The refrigerator 1 according to the present invention further includes the outer cover 47 covering the door contacting part 55 and allowing the heat transferred to the radiating part 50 to transfer only to the outer door plate 21 through the door contacting part 55.

It is preferable that the outer cover 47 may be provided in a rectangular plate shape in which a display accommodating part 40a is formed, to thereby enhance the appearance of the door 20 mounted with the radiating part 50. The outer cover 47 surrounds the display unit 30, covers the upper portion of the radiating part 50, attaches to the outer door plate 21 to which the door contacting part 55 is mounted, and covers a portion of the door 20. Accordingly, a user may touch the outer cover 47 without feeling the heat directly.

The operation of the refrigerator 1 according to the first embodiment of the present invention will be described.

As the display unit 30 operates, heat is generated from an inner portion of the display unit 30. The heat is transferred to the radiating part 50 through the rear cover 35 of the display unit 30. The door contacting part 55 of the radiating part 50 surface-contacts with the outer door plate 21 and radiates the heat transferred from the display unit 30. With this operation, the heat generated from the display unit 30 may be radiated efficiently without noises.

Hereinafter, a refrigerator according to a second embodiment of the present invention will be described in detail by referring to the figures.

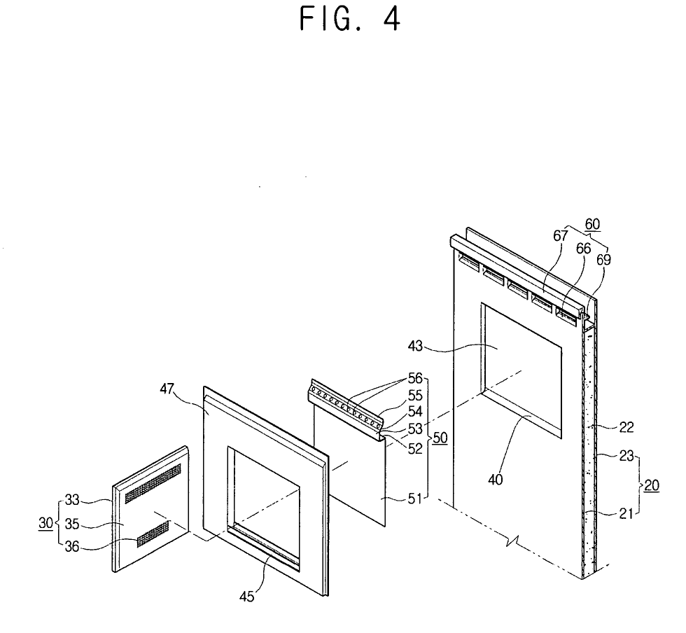

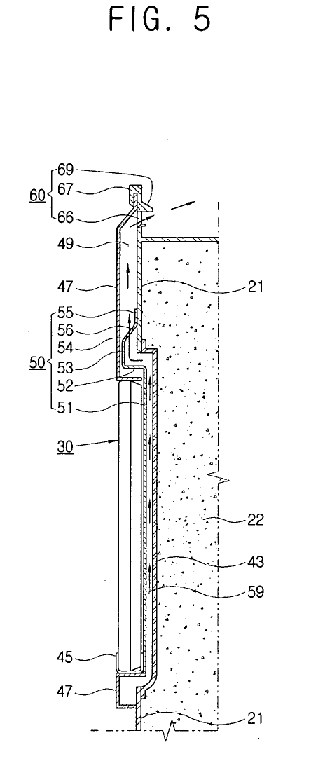

FIG. 4 is an exploded perspective view illustrating a main portion of a refrigerator according to a second embodiment of the present invention, and FIG. 5 is a sectional view illustrating the main portion of the refrigerator in FIG. 4.

As shown in FIGS. 1, 4 and 5, a refrigerator 1 according to a second embodiment of the present invention includes a main body 10, a door 20, a display unit 30 forming an image, a display accommodating part 40, a radiating main body 51, a door contacting part 55, and a radiating part 50 having a ventilating part 56 formed between the radiating main body 51 and the door contacting part 55.

The radiating part 50 includes the radiating main body 51 spaced from the display accommodating part 40 to form a predetermined space 59 therebetween, a horizontal bent part 52 bent from an upper portion of the radiating main body 51, a vertical bent part 53 bent in a vertical direction from the horizontal bent part 52, an inclining part 54 inclined from the vertical bent part 53, the door contacting part 55 bent from the inclining part 54 and contacting with an outer door plate 21, and the ventilating part 56 formed in the inclining part 54. The radiating part 50 is preferably formed of metal material with good thermal conductivity to transfer heat generated from the display unit 30 to the outer door plate 21, and thereby radiating the heat. Also, the radiating part 50 is preferably formed in a plate shape.

The space 59 is formed between the radiating main body 51 and the display accommodating part 40. The radiating main body 51 contacts with a rear cover 35 of the display unit 30, and contacts with the outer door plate 21 through the door contacting part 55 to exchange heat. The radiating main body 51 is preferably formed in a plate shape. The space 59 between the display accommodating part 40 and the radiating main body 51 prevents the heat of the radiating part 50 transferred from the display unit 30 from transferring to the storage compartment directly.

The horizontal bent part 52 is bent from the upper portion of the radiating main body 51. The horizontal bent part 52 is spaced at a predetermined distance from the display accommodating part 40 and the outer door plate 21, and expands the space 59 up to an upper portion of the radiating part 50.

The vertical bent part 53 is bent in the vertical direction from the horizontal bent part 52.

The inclining part 54 is inclined toward the outer door plate 21 at a predetermined angle from the vertical bent part 53. The inclining part 54 supplies an elastic force to allow the door contacting part 55 to be supported to the outer door plate 21. Accordingly, the door contacting part 55 may surface-contact with the outer door plate 21 without contact inferiority.

The door contacting part 55 extends in the planar direction of the outer door plate 21 from the inclining part 54 to contact with the outer door plate 21 and to support the outer door plate 21, so that the radiating part 50 may transfer the heat to the outer door plate 21 through the upper portion of the radiating part 50. The door contacting part 55 preferably surface-contacts with the outer door plate 21. Thus, the door contacting part 55 may transfer the heat transferred from the display unit 30 to the outer door plate 21, and thereby radiating the heat. The door contacting part 55 preferably has such a length as to radiate efficiently the heat. The radiating part 50 is preferably formed in a rectangular plate shape as illustrated in FIG. 4, but alternatively, the radiating part 50 may be formed in other various shapes as long as the radiating part 50 may contact with the rear cover 35 of the display unit 30 to transfer the heat to the outer door plate 21. The door contacting part 55 is provided in the upper portion of the radiating part 50 to surface-contact with the outer door plate 21, but alternatively, the door contacting part 55 may be provided in a lower portion of the radiating part 50, or in both upper and lower portions thereof to expand contact areas with respect to the outer door plate 21. Also, the door contacting part 55 may be provided around a circumference thereof.

The ventilating part 56 is formed by cutting off a plate portion of the inclining part 54 so that air inside of the space 59 can flow therethrough. The ventilating part 56 may be formed in various shapes and numbers as long as air in the space 59 can flow therethrough. For example, the ventilating part 56 may be formed in a circular shape or a polygonal shape such as a rectangular shape. Also, the ventilating part 56 may be formed as a slit elongated in a horizontal direction, or as a plurality of vertical slits. Thus, the air inside of the space 59 can flow through the ventilating part 56.

The refrigerator 1 according to the present invention further includes an outer cover 47 disposed in front of the radiating part 50 to cover the door contacting part 55 and to space a predetermined space 49 with respect to the outer door plate 21. The outer cover 47 is distanced from the outer door plate 21 at a predetermined distance, and an upper end portion of the outer cover 47 is coupled with an upper end portion of the outer door plate 21 to form the space 49. The outer cover 47 is preferably provided in a rectangular plate shape in which the display accommodating part 40 is provided, and thereby enhancing the appearance of the door 20 mounted with the radiating part 50. The outer cover 47 surrounds the display unit 30, covers an upper portion of the radiating part 50, and covers a portion of the outer door plate 21. Accordingly, a user may touch the outer cover 47 without feeling the heat directly.

The refrigerator 1 further includes a door ventilating member 60 which has an outer cover supporting part 67 supporting the upper end portion of the outer cover 47 to the door 20, and a door ventilating part 66 formed in an upper end portion of the outer door plate 21 to discharge air passed through the ventilating part 56 to the outside. The door ventilating member 60 may be formed by extending the outer door plate 21 over an upper end portion of a foaming space 22, or by recessing an upper end portion of the foaming space 22.

The outer cover supporting part 67 may be formed in various configurations to support the outer cover 47 to the outer door plate 21. The outer cover supporting part 67 is twice bent to be coupled to the upper end portion of the outer cover 47 as illustrated in FIG. 6, but alternatively, the outer cover supporting part 67 may be coupled thereto by a separate coupling member.

The door ventilating part 66 is formed by cutting off a predetermined portion of the door ventilating member 60 to allow the air inside of the space 59 between the radiating main body 51 and the display accommodating part 40 to be discharged to the outside through the ventilating part 56. The door ventilating part 66 may be formed in various shapes and numbers as long as the air inside of the space 49 between the outer cover 47 and the outer door plate 21 can be discharged to the outside. The door ventilating part 66 may be formed in a circular shape or a polygonal shape such as a rectangular shape. Also, the door ventilating part 66 may be formed as a slit elongated in a horizontal direction, or as a plurality of vertical slits. Herein, the door ventilating part 66 may be disposed to correspond to the ventilating part 56 in a vertical direction. Accordingly, the air inside of the space 59 can be discharged to the outside through the door ventilating part 66 via the ventilating part 56.

The door ventilating part 66 is preferably distanced at a predetermined height from the upper end portion of the foaming space 22. Thus, in the case that on the upper end portion of the foaming space 22, foreign substances stacks or water stagnates, the foreign substances or the water can be prevented from passing into the space 49 through the door ventilating part 66.

A lower portion of the door ventilating part 66 may be downward inclined toward the outer cover 47. Accordingly, the air may flow smoothly.

The door ventilating member 60 of the refrigerator 1 according to the embodiment further includes a protruding part 69 protruding toward an inner door plate 23 from the door ventilating part 66. The protruding part 69 prevents foreign substances or water from passing in through an upper portion or a side portion of the door ventilating part 66. The protruding part 69 may be formed in various configurations. The protruding part 69 may protrude from only an upper portion of the door ventilating part 66, or the protruding part 69 may protrude to surround the door ventilating part 66.

The operation of the refrigerator 1 according to the second embodiment of the present invention will be described.

As the display unit 30 operates, heat is generated from an inner portion of the display unit 30. The heat is transferred to the radiating part 50 through the rear cover 35 of the display unit 30. The heat transferred to the radiating main body 51 is transferred to the door contacting part 55, and the door contacting part 55 surface-contacts with the outer door plate 21 and radiates the heat transferred from the display unit 30. Herein, as illustrated in FIG. 6, air contacting with the radiating part 50 can be discharged to the outside through the ventilating part 56 and the door ventilating part 66.

As described above, the refrigerator 1 according to the present invention includes the radiating part 50 contacting with the display unit 30 and the outer door plate 21 to exchange the heat, and thereby efficiently radiating heat generated from the display unit 30.

Also, the refrigerator 1 further includes the ventilating part 56 and the door ventilating part 66 to discharge air contacting with the radiating part 50 to the outside, and thereby more efficiently radiating the heat.

As described above, the present invention provides the refrigerator efficiently radiating heat generated from the display unit.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A refrigerator comprising a main body forming a storage compartment to have an opening part in a front side thereof, and a door opening/closing the opening part and including an outer door plate and an inner door plate distanced from each other to form a foaming space therebetween, comprising:
a display unit displaying an image;
a display accommodating part formed in the door to accommodate the display unit; and
a radiating part interposed between the display unit and the outer door plate to contact therewith respectively, and transferring heat generated from the display unit to the outer door plate.

2. The refrigerator according to claim 1, wherein the display accommodating part is formed to be concave in the door, and
the radiating part comprises a radiating main body forming a predetermined space with respect to the concave portion of the display accommodating part, and a door contacting part contacting with the outer door plate.

3. The refrigerator according to claim 2, wherein the radiating part further comprises a horizontal bent part bent from an upper portion of the radiating main body, a vertical bent part bent from the horizontal bent part, and an inclining part inclined from the vertical bent part.

4. The refrigerator according to claim 3, wherein the concave portion of the display accommodating part is formed by cutting off the outer door plate, and
the refrigerator further comprises a sealing member preventing a foaming material from leaking out of the cutting portion.

5. The refrigerator according to claim 4, wherein the radiating part comprises at least one of aluminum and copper.

6. The refrigerator according to claim 5, further comprising an outer cover provided in front of the radiating part to cover the door contacting part and allowing the heat transferred to the radiating part to transfer to the outer door plate through the door contacting part.

7. The refrigerator according to claim 6, wherein the display unit comprises a display panel forming an image, a front cover supporting a front side of the display panel, and a rear cover covering a rear side of the display panel and contacting with the radiating part coupled with the front cover to transfer heat, and
the rear cover is provided with a plurality of through holes.

8. A refrigerator comprising a main body forming a storage compartment to have an opening part in a front side thereof, and a door opening/closing the opening part and including an outer door plate and an inner door plate distanced from each other to form a foaming space therebetween, comprising:
a display unit displaying an image;
a display accommodating part formed in the door to accommodate the display unit; and
a radiating part including a radiating main body forming a predetermined space with respect to the display accommodating part, a door contacting part bent from an upper portion of the radiating main body to contact with the outer door plate, and a ventilating part interposed between the radiating main body and the door contacting part.

9. The refrigerator according to claim 8, further comprising an outer cover disposed around a circumference of the display accommodating part to cover the door contacting part and to form a predetermined space with respect to the outer door plate, and
a door ventilating part provided in an upper portion of the outer door plate to discharge air passed through the ventilating part to the outside.

10. The refrigerator according to claim 9, wherein the radiating part further comprises a horizontal bent part bent from an upper portion of the radiating main body, a vertical bent part bent from the horizontal bent part, and an inclining part inclined between the vertical bent part and the door contacting part, and
the ventilating part is formed in the inclining part.

11. The refrigerator according to claim 10, wherein the door ventilating part is distanced at a predetermined height from an upper end portion of the foaming space.

12. The refrigerator according to claim 11, further comprising a protruding part protruding toward the inner door plate from the door ventilating part.

13. The refrigerator according to claim 12, wherein the display accommodating part is formed by cutting off the outer door plate, and
the refrigerator further comprises a sealing member preventing a foaming material from leaking out of the cutting portion.

14. The refrigerator according to claim 13, wherein the display unit comprises a display panel forming an image, a front cover supporting a front side of the display panel, and a rear cover covering a rear side of the display panel to be coupled with the front cover and contacting with the radiating part to transfer heat, and
the rear cover is provided with a plurality of through holes.

15. The refrigerator according to claim 8, wherein the radiating part comprises at least one of aluminum and copper.

16. The refrigerator according to claim 8, wherein the display accommodating part is U-shaped.

17. The refrigerator according to claim 8, wherein the display unit is detachably mounted in the display accommodating part.

18. The refrigerator according to claim 8, wherein the radiating part is formed in a plate shape.
